(19) United States
(12) Patent Application Publication
(10) Pub. No.: US 2010/0138797 A1
(43) Pub. Date: Jun. 3, 2010

(54) PORTABLE ELECTRONIC DEVICE WITH SPLIT VISION CONTENT SHARING CONTROL AND METHOD

(75) Inventor: Karl Ola THORN, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/325,486

(22) Filed: Dec. 1, 2008

(51) Int. Cl. G06F 3/033

(52) U.S. Cl. 715/863

(57) ABSTRACT

A portable electronic device, such as a mobile phone, has a main camera and a video call camera that are receive optical input representative of motion of a user's hand(s) or hand gestures. The motion or gestures are decoded and used as a remote control input to control the displaying of content by a display device, such as a television or a projector, which receives the content for display from the mobile phone. A method of displaying content from a portable electronic device on a separate display or projector and of controlling such displaying by remote control based on hand movement or gestures.

### TECHNICAL FIELD OF THE INVENTION

The technology of the present disclosure relates generally to apparatus and method for sharing content from a portable electronic device, and, more particularly, for controlling such content sharing by sensing images, motion, gestures, or the like by one or more cameras associated with the portable electronic device.

### BACKGROUND

Portable electronic devices, such as, for example, mobile wireless electronic devices, e.g., mobile telephones (referred to below as mobile phones), portable digital assistants (PDAs), etc., are increasing in popularity. For example, mobile phones, PDAs, portable computers, portable media players and portable gaming devices are in widespread use. Features associated with some types of portable electronic devices have become increasingly diverse. To name a few examples, many electronic devices have cameras, text messaging, Internet browsing, electronic mail, video and/or audio playback, and image display capabilities. Many have hands free interfaces with capabilities for connecting to external speakers and microphones as well as wired and wireless communication capabilities, such as, for example, short distance communication capability, e.g., Bluetooth communication functions, and the like.

Portable electronic devices, e.g., mobile phones, PDAs, media players, etc., also have the capability to output content, e.g., to show content such as pictures, movies, lists, functions, such as those represented by a graphical user interface (GUI), etc. on a display; to play the content such as sound, e.g., music or other sounds, via one or more speakers, such as, for example, an internal speaker of the device or external speakers connected by wire or wirelessly to an output of the device, etc. Various wired and wireless coupling techniques have been used and may be used in the future, such as, for example, Bluetooth communication functions, or other coupling techniques.

### SUMMARY

Sometimes a user of a portable electronic device may want to share content with one or more other persons. The displays on portable electronic devices, such as mobile phones, PDAs, media players, etc., are rather small and it may be a problem for several persons simultaneously to view the display and to see and to understand all information, image details, etc. being shown on the display. It also may be a problem to use the content, e.g., to select a function or a listed item, or to change the content, e.g., to scroll between images, that are shown on the display. Also, the user interface for such portable electronic devices may be optimized for the relatively small display screen of the device lo and not optimal for a large area display.

Briefly, according to an aspect of the invention, a user of a mobile phone may make hand gestures, movements or the like that are sensed by one or more cameras of the mobile phone and used to control the displaying, presenting and/or use of content from the mobile phone.

According to another aspect, a portable electronic device includes an input device adapted to receive a plurality of input images, a comparator configured to recognize at least one of a plurality of predetermined motions by comparing input images, and a controller configured to control an output of the portable electronic device in response to the respective motions recognized by the comparator, wherein the type of control corresponds to the recognized motion.

According to another aspect the device includes an output device configured to provide such output as displayable content.

According to another aspect, the displayable content is at least one of a picture, a list, or a keyboard.

According to another aspect, the comparator is configured to recognize a plurality of different predetermined motions, and the controller is configured to change at least one of size or location of an image of displayable content in response to respective motions recognized by the comparator.

According to another aspect, the controller is configured to scroll an image of displayed information in response to respective motions recognized by the comparator.

According to another aspect, the controller is configured to cause a selection function with respect to an image of displayed information in response to respective motions recognized by the comparator.

According to another aspect, the output device is configured to transmit the displayable content by wireless, wired or other coupling to be shown by at least one of a television, projector, display, monitor, or computer that is remote from the portable electronic device.

According to another aspect, the comparator includes a processor and associated logic configured to compare a plurality of images.

According to another aspect, the comparator is configured to compare recognized motions represented, respectively, by a first plurality of input images from a first direction and by a second plurality of input images from a second direction that is different from the first direction.

According to another aspect, the input device includes at least one camera.

According to another aspect, the input device includes two cameras relatively positioned to receive input images from different directions.

According to another aspect, at least one of the cameras is a video camera.

According to another aspect, the device comprises a mobile phone having two cameras as the input device to provide input images from different directions, and wherein one camera is a video call camera and the other is a main camera of the mobile phone.

According to another aspect, a method of operating a portable electronic device, includes comparing input images to recognize at least one of a plurality of predetermined motions, and controlling an output of the portable electronic device in response to the respective recognized motions, wherein the type of controlling corresponds to the recognized motion.

According to another aspect, the comparing further includes comparing recognized motions represented, respectively, by a first plurality of input images from a first direction and by a second plurality of input images from a second direction that is different from the first direction.

According to another aspect, the controlling an output includes controlling content intended to be displayed.

According to another aspect, the controlling includes controlling content provided by the portable electronic device to be shown on a device separate from the portable electronic device.

According to another aspect, the controlling includes controlling operation of a device separate from the portable electronic device.

According to another aspect, the portable electronic device is a mobile phone, and two cameras of the mobile phone are used to obtain input images from two different directions for use in carrying out the comparing step.

According to another aspect, computer software embodied in a storage medium to control an electronic device includes comparing logic configured to compare input images to recognize whether motion having a predetermined characteristic is represented by the results of the comparison, and control logic responsive to recognizing by the comparing logic of motion having a predetermined characteristic and configured to provide a type of control of an output of the electronic device in correspondence to the recognized motion.

According to another aspect, the comparing logic further includes logic configured to compare two recognized motions having respective predetermined character motions.

According to another aspect, a method of using a mobile phone to display content, includes moving at least one of an arm, hand, or finger relative to a mobile phone having the capability of sensing the extent and/or type of such movement, thereby to provide an input to the mobile phone to control the displaying of content provided by the mobile phone.

According to another aspect the moving includes moving both left and right at least one arms, hands, or fingers, respectively, relative to different cameras of the mobile phone to cause a desired control of the displaying of content provided by the mobile phone.

These and further aspects and features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

It should be emphasized that the term “comprises/comprising” when used in this specification is taken to specify the presence of stated features, integers, steps or components but does not preclude the presence or addition of one or more other features, integers, steps, components or groups thereof.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIGS. 1A and 1B are a schematic front view and schematic isometric back view of a mobile phone embodying the invention;

FIG. 2 is a schematic illustration depicting use of the mobile phone of FIG. 1, for example, to present content to be shown on a display that is separate from the mobile phone;

FIG. 3A is a schematic illustration of an image shown on a display and hand motions or gestures to cause a zoom out or image size reduction effect;

FIG. 3B is a schematic illustration of an the image of FIG. 3A shown on a display and hand motions or gestures to cause a zoom in or image enlargement effect;

FIG. 4A is a schematic illustration of an the image of FIG. 3A shown on a display and hand motions or gestures to cause a panning or moving of the displayed image toward the right of the display relative to the illustration;

FIG. 4B is a schematic illustration of an the image of FIG. 4A shown on a display and hand motions or gestures to cause a panning or moving of the displayed image toward the left of the display relative to the illustration;

FIGS. 5A, 5B and 5C are illustrations of a display showing a list of names, hand movements or gestures to scroll through the list, and a hand gesture to select a name in the list;

FIG. 6A is a schematic illustration of a keyboard shown on a display and hand movement or gesture to point to a key of the keyboard;

FIG. 6B is a schematic illustration of a hand movement or gesture to select the key pointed to as shown in FIG. 6A;

FIG. 7 is a schematic block system diagram of the mobile phone of FIGS. 1 and 2;

FIG. 8 is a relatively high level exemplary flow chart or logic diagram representing an exemplary method of use of a mobile phone or other mobile wireless electronic devices embodying the invention to carry out the method described herein;

FIG. 9 is an exemplary flow chart or logic diagram representing an exemplary method of use of a mobile phone or other mobile wireless electronic device embodying the invention to carry out the method described herein, e.g., for zooming in, panning, scrolling and selecting functions; and

FIG. 10 is an exemplary flow chart or logic diagram representing an exemplary method of use of a mobile phone or other mobile wireless electronic device embodying the invention to carry out typing or other keyboard functions; and

FIG. 11 is a schematic illustration depicting use of the mobile phone of FIG. 1, for example, to present content to be projected to a screen, for example, by a projector that is separate from the mobile phone;

FIG. 12 is a schematic illustration of an accessory used with a primary device to provide remote control and/or content;

FIG. 13 is a schematic illustration of an embodiment including two electronic devices, each having its own camera;

FIG. 14 is a schematic illustration of an embodiment including one electronic device with a camera and a web camera;

FIG. 15 is a schematic illustration of an embodiment including an electronic device with a movable camera; and

FIG. 16 is a schematic illustration of an embodiment including electronic devices with rotatable cameras.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a mobile wireless electronic device in the form of a portable radio communications device, such as the illustrated mobile phone. It will be appreciated, however, that the exemplary context of a mobile phone is not the only operational environment in which aspects of the disclosed systems and methods may be used. Therefore, the techniques, methods and structures described in this document may be applied to any type of appropriate electronic device, examples of which include a mobile phone, a mobile wireless electronic device, a media player, a gaming device, a computer, e.g., a laptop computer or other computer, ultra-mobile PC personal computers, GPS (global positioning system) devices, a pager, a communicator, an electronic organizer, a personal digital assistant (PDA), a smartphone, a portable communication apparatus, etc., and also to an accessory device that may be coupled to, attached, to, used with, etc., any of the mentioned electronic devices or the like.

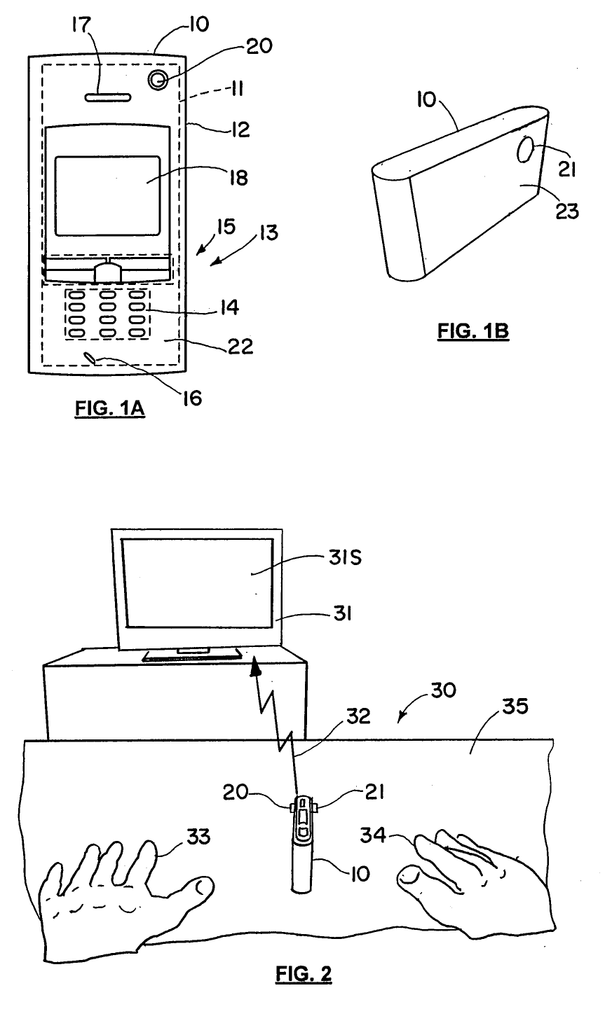

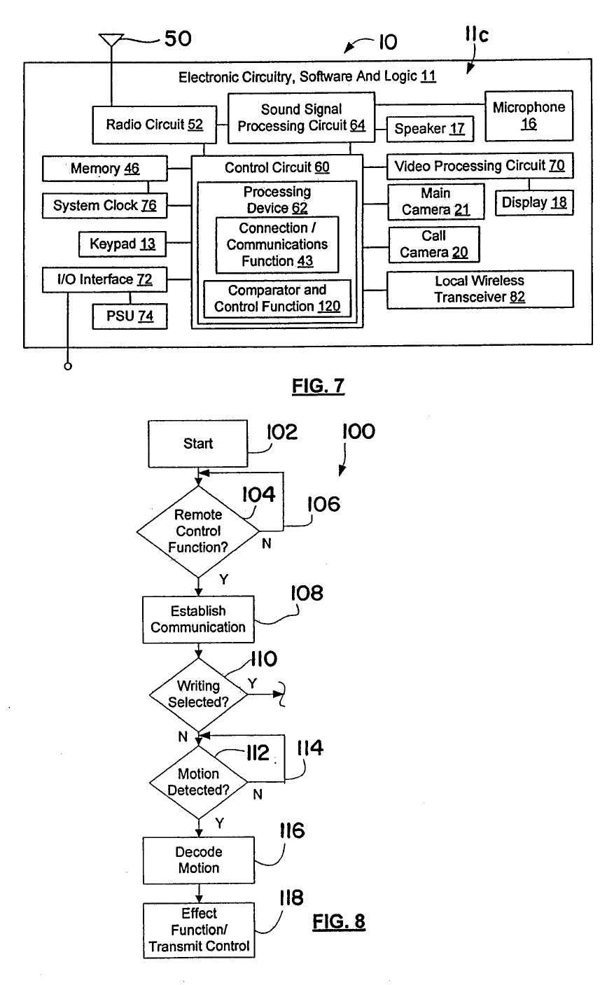

Referring initially to FIGS. 1 and 2 an embodiment of the invention is illustrated generally at 10 in the form of a mobile wireless electronic device (referred to below as “mobile phone”). The mobile phone 10 includes suitable electronics, circuitry and operating software, hardware and/or firmware represented at 11 and shown and described in greater detail with respect to FIG. 7. The mobile phone 10 includes a case 12 on and with which are mounted various parts of the mobile phone, for example, as is conventional. The mobile phone 10 is shown having a brick shape or block shape configuration, but it will be appreciated that the mobile phone may be of other shapes, e.g., flip type case, slide case, etc.

The mobile phone 10 includes, for example, a keypad 13, having twelve alphanumeric dialing and/or input keys 14 and having a number of special keys 15, such as, for example, function keys, navigation keys, soft keys/soft switches, all of which keys in the keypad may be conventional or may have new designs and/or functions. The mobile phone 10 also includes a microphone 16 for audio input, e.g., voice, a speaker 17 for audio output, e.g., sound, voice, music, etc., and a display 18. The display 18 may be any of various types, such as, for example, a liquid crystal display (LCD), a light emitting diode (LED) display, etc. The display may be a touch sensitive display that provides an electronic input to the circuitry 11 of the mobile phone 10 when touched by a finger, stylus, etc. If desired, the display may be configured to display many types of data, icons, etc., such as, for example, lists of data, a graphical user interface (GUI) in which icons or lists represent operational functions that would be carried out by the mobile phone when selected, e.g., by touching a stylus to the display, etc. The display may be of a type the displays part or all of a keypad, such as one representing all or some of the keys 14, 15 of the keypad 13. In an embodiment the display may be of a type that displays a typewriter or computer keyboard, such as, for example, an English language QWERTY keyboard or some other keyboard. The type of images that can be shown on the display and functions or inputs to the mobile phone that can be provided the mobile phone by touching the display or other keys may be many and varied including many that currently are known and available and others that may come into existence in the future.

In response to the various inputs provided the mobile phone 10 via the keypad 13, display 18, and possibly from external sources, e.g., in response to an incoming telephone call, text message, beaming, short message system (SMS), etc. the circuitry 11 will respond and the mobile phone is thus operated.

The mobile phone 10 also includes two cameras 20, 21. The cameras may be identical or different. In an embodiment the cameras are of the electronic type, e.g., having digital capabilities to store as electronic signals or data images representative of inputs received by the respective camera. For example, the camera 20 may be a video call camera that typically faces the user of the mobile phone 10 to obtain one image or a sequence of images of the user and to transmit that image to another mobile phone or the like for viewing by the user of the other mobile phone during a phone conversation with the user of the mobile phone 10. The other camera 21 may be the main camera of the mobile phone 10, and it may have various capabilities such as to take still pictures, videos, etc. The cameras 20, 21 may be other types of cameras, as may be desired. In the illustration of FIGS. 1A and 1B the camera 20 faces the front 22 of the mobile phone 10 and the camera 21 faces the back 23 of the mobile phone. Reference to front and back is for convenience of description; but it will be appreciated that either side of the mobile phone 10 may be artificially designated front or back.

The cameras 20, 21 receive inputs, e.g., an optical input of a scene, portrait, face, etc., which may be received via a camera lens or may impinge directly or impinge via some other mechanism, such as a light conducting member, fiber optic device, etc., onto a light sensitive device, element, number of elements, etc. The camera inputs may be represented by visible light or by some other form of light, e.g., infrared, and the light sensitive device may be sensitive to only visible light and/or to other wavelengths of electromagnetic energy.

Turning to FIG. 2, a presentation system 30 is illustrated. The presentation system includes the mobile phone 10, a display device 31, and a connection 32 between the mobile phone and the display device. The mobile phone 10 provides content via the connection 32 to be shown on the display device 31. As was mentioned above, the content may be an image, such as a photograph; a video; a graphical user interface (GUI); a list of data or information, e.g., a contacts list from the contacts memory of the mobile phone 10; a document in word processing format, portable document format (pdf), etc.; a keyboard, such as a QWERTY English language or some other language keyboard or some other alphanumeric keyboard or keypad, etc.; audio output; or virtually any other content.

The display device 31 may be a conventional television, e.g., a digital television, analog television or some other type of television with appropriate input circuitry to receive signals from the mobile phone 10 via the connection 32 and to provide those signals to the television to show images on the television. Exemplary circuitry may be included in the television or may be in a separate packaging, box, etc., and may be, for example, of a type typically used in connection with converting cable television signals, satellite television signals or other signals to appropriate form for operating the television to show desired images represented by the signals. The display device 31 may be a computer monitor, and the signals from the mobile phone 10 received via the connection 32 may be appropriate for directly driving the monitor. The display device may include an associated computer capable of converting signals received via the connection 32 to appropriate type or format for showing of corresponding images on the display device 31.

The connection 32 may be a wired or a wireless connection from the mobile phone 10 to the display device 31. The connection 32 may be provided via a DLNA output or protocol from the mobile phone 10 to the display device 31. (DLNA is an acronym for Digital Living Network Alliance, which is a coalition of computer and consumer electronics companies that cooperate to ensure interoperability in home networks. DLNA is based on industry standards, such as the IP network protocol, Wi-Fi wireless protocol and UPnP (an open networking architecture) transfer protocol. The connection may be provided via a TV OUT output from the mobile phone 10, e.g., an output of electrical signals that are of suitable format to operate a television display device 31, etc.

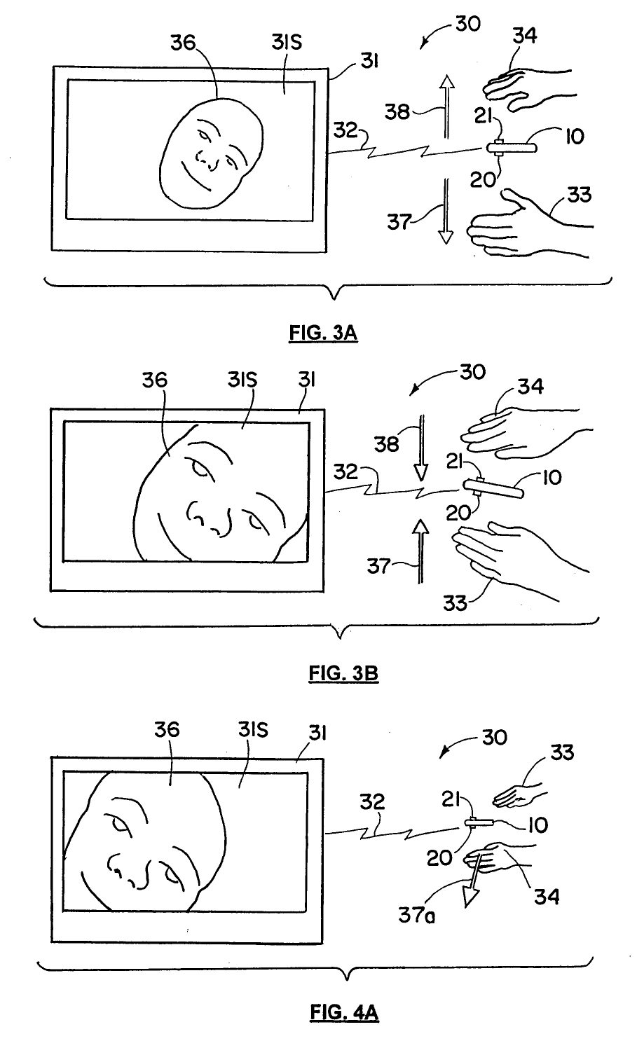

Operation of the mobile phone 10 in the presentation system 30 is described by way of several graphical examples that are illustrated, respectively, in FIGS. 3, 4, 5 and 6. The cameras 20, 21 and circuitry and/or software or logic of the mobile phone 10 may be used to detect distance of a user's hands 33, 34 from the mobile phone, e.g., from a respective camera that receives an optical input representing a respective hand, and also movement, direction of movement, gestures and speed of movement of each hand, etc. The information so detected, e.g., speed, direction, position, gesture, etc., may be used to control operation of the mobile phone and the way in which content is displayed and/or used, as is described further below. It will be appreciated that there are other ways and methods to use the mobile phone 10 in a presentation system 30 or otherwise to carry out similar principles that are described with respect to these drawing figures, as will be evident to persons having ordinary skill in the art. Such other ways and methods are considered a part of the present invention.

As is shown in FIG. 2, to facilitate relative positioning of the mobile phone 10 and the hands 33, 34 of the user, the mobile phone may be placed on a surface, for example, a table 35, and the hands may be slid along the surface of the table while being observed by the respective cameras 20, 21 and, thus, providing inputs to the cameras. The mobile phone may be positioned relative to a display device 31 to facilitate making the connection 32 either wirelessly or wired and also to facilitate an intuitive sense that as the respective hands are moved corresponding action is carried out or shown on the display screen 31s. For example, as is described below, as both hands are moved toward or away from the mobile phone 10, one hand is moved toward or away from the mobile phone, or one hand is moved toward or away from the display device, zooming, panning or scrolling functions may be carried out and shown on the display screen 31s.

As is described herein, the mobile phone 10, display device 31 and connection 32 between them provide a presentation system 30. In the presentation system 30 content provided by the mobile phone 10 is shown on the display device. The content that is shown on the display device may be controlled by moving one or both of a user's hands 33, 34. One or more images representing location of a hand, locations of the hands, movement or motion of the hands, are used by the mobile phone to control operation of the mobile phone and the showing of content on the display device. The images that may be shown as content on the display 18 of the mobile phone 10 may be shown on the display device 31 in a manner that may be viewed easily by one or more persons. Other content, e.g., audio content that may be played by one or more speakers of the mobile phone 10, to the display device 31 or otherwise provided, also may be controlled by the hand motion and/or gestures as are described by way of examples herein.

Turning to FIG. 3A, use of the mobile phone 10 in a presentation system 30 is exemplified to show an image of a face 36 on the display device 31. Relative to the size of the display device 31 screen 31s, the face 36 is relatively small; or at least the entire face is shown on the display. The two hands 33, 34 of a user of the mobile phone 10 (referred to below as “user”) are shown in position relative to the mobile phone such that the cameras 20, 21 are able to receive optical inputs representing the hands. The optical inputs to the respective cameras may be converted to image data, such as, for example, electrical signals in the mobile phone, and the image data may be used as is described below. For convenience the image data may be referred to below as image or images; and the optical inputs to the cameras 20, 21 may be referred to below simply as inputs.

In FIG. 3A is an example of zooming out or zooming away with respect to the image of the face 35 shown on the screen 31s of the display device 31. For example, as is represented by the arrows 37, 38, the hands 33, 34 of the user are shown moving away from the mobile phone 10 while still being in view of and providing inputs to the respective cameras 20, 21. As is described further below, the mobile phone 10 includes circuitry and programming to detect or to sense the changes in the images representing the inputs to the cameras 20, 21, e.g., sensing that the hands are moving away from the cameras and, for example, appearing smaller as such motion occurs. The cameras may include automatic focusing functions that can provide information of such motion, e.g., as the automatic focusing functions try to maintain the hands in focus. The mobile phone 10 may include comparator functions to compare one or more images to determine that such motion away from the cameras is occurring.

As the user moves the hands 33, 34 away from the mobile phone 10, then, the circuitry of the mobile phone changes the content, e.g., the image of the face 36, to make it smaller relative to the size of the screen 31s. This is an operation similar to zooming out relative to an image to make the parts of the image smaller while showing more information in the image, e.g., other portions of the body and/or the surrounding environment in which the face 36 is located within the displayed image thereof.

Turning to FIG. 3B, an example of operating the mobile phone 10 in the presentation system 30 to display content by zooming in to the image of the face 36 shown on the screen 31s is illustrated. The arrows 37, 38 are shown pointing toward each other; and the user's hands 33, 34 are moved in the direction represented by the arrows toward the mobile phone 10 while in view of the cameras 20, 21. As the hands move toward the mobile phone 10, they may be said to “move in” toward the mobile phone; and the image of the face 36 is zoomed in and, thus, is enlarged relative to the size of the display screen 31s. In FIG. 3B the mobile phone 10 is shown slightly canted or at an angle relative to the an axis parallel to the user's arms; this indicates that the operation described with respect to FIGS. 3A and 3B to zoom in or to zoom out may be carried out even though the hands are not moved precisely in a direction that is perpendicular to the major axis of the mobile phone or parallel to the line of sight of the respective cameras. The logic and software used for image comparison and/or for automatic focusing, etc. may be sufficiently accommodating and/or forgiving to provide the desired zooming in or out even though the parts of the mobile phone are not perfectly aligned with respect to the motion of the hands 33, 34.

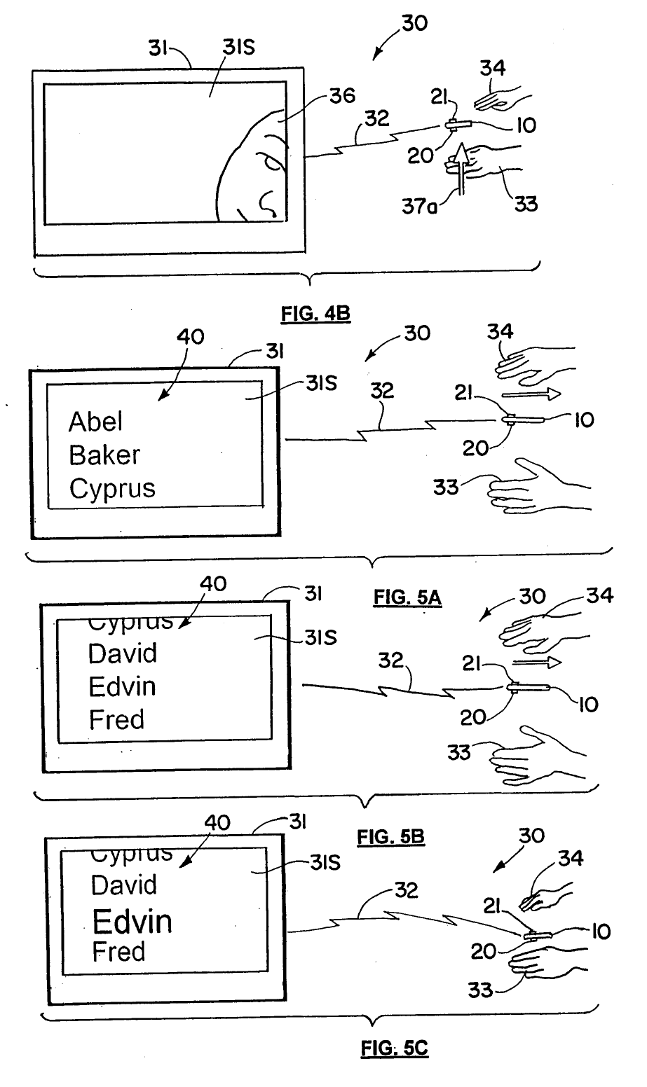

FIGS. 4A and 4B illustrate another operation of the mobile phone 10 to pan an image or content shown on the screen 31s of the display device 31. Only one hand, e.g., the left hand 33, is moved relative to the mobile phone 10 while the other hand 34 is not moved. Camera 20 senses the motion of the hand 33 as it is moved away from the mobile phone 10 and camera 20 (FIG. 4A) or toward the mobile phone and camera (FIG. 4B), as is represented by the respective arrows 37a. In response to detecting such motion or gesture of only one hand 33 based on the input received by only one camera, e.g., camera 20, while no motion, e.g., of the other hand 34, is detected by the other camera, e.g., camera 21, the circuitry and/or software and logic of the mobile phone may pan the image of the face 36 shown on the screen 31s to the left, as is illustrated in FIG. 4A, or to the right, as is illustrated in FIG. 4B. The description just above of moving only one hand 33 refers to moving only the left hand to effect panning, as is illustrated in the drawing; but, if desired, the movement to effect panning may be provided by moving only the right hand 34. As will be appreciated, panning is quite useful when the content provided by the mobile phone 10 in the presentation system 30 is a map, thus allowing the user to pan a map across the screen 31s to show different parts of the map. Similarly, zooming to show greater or less detail and/or greater or less surrounding information also is quite useful when a map is shown by the presentation system on the display device 31.

FIGS. 5A, 5B and 5C illustrate another operational example of using the mobile phone 10 to scroll through a list 40 as the content and to select an element in the list. The list may be a list of names, places, amounts, or virtually any list of items, information, etc. The illustrated list 40 is a list of names. The user may scroll through the list by sliding one hand, e.g., the right hand 34, along the table in a direction toward or away from the user. The moving hand provides an optical input to the camera 21, for example, and in turn the mobile phone detects the motion of the moving hand. The circuitry and software or logic of the mobile phone 10 responds to such motion to scroll up or down in the list 40 that is shown by the display device 31. For example, motion toward user and away from the display device 31 causes scrolling down the list 40; and motion away from the user and toward the display devices causes scrolling up the list.

FIG. 5A illustrates the top of an alphabetical list 40. FIG. 5B shows a middle portion of the alphabetical list 40. As scrolling occurs, different respective names in the list are highlighted to identify which of the names is ready to be selected. For example, if the list 40 were a list of contacts for whom respective telephone numbers are stored in a memory of the mobile phone 10, then highlighting may indicate the contact of which a telephone number is ready to be dialed by the mobile phone 10 if that contact were actually selected. This is but one example of selection; being selected may provide for displaying of other information of the contact, e.g., residence address, email address or other address information, a photograph of the contact, etc. As is illustrated in FIG. 5C, selection of the name Edvin, which had been highlighted in the list 40 as being ready for selection, may be carried out by using the left hand 33 and lifting it up out of camera view and quickly moving the hand down to the same position prior to the lifting. Such movement of the left hand may simulate and intuitively represent a “click” action, as in the clicking of a button on a computer mouse. It will be appreciated that scrolling and clicking/selection may be carried out using the opposite hands to those described just above in the example of FIGS. 5A, 5B and 5C.

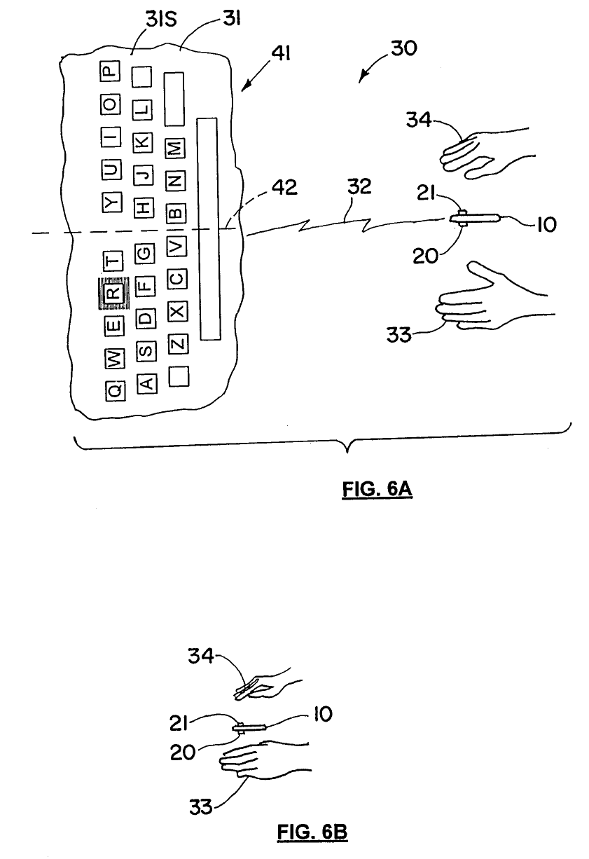

Turning to FIGS. 6A and 6B, an alphanumeric keyboard 41 is shown by the display device 31. In the illustration of FIG. 6A the keyboard 41 is a QWERTY keyboard typically used for English language typewriters and computer keyboards. The keyboard may be of a type used for other purposes, e.g., for typing in other languages. Each hand 33, 34 may in effect map to one half of the keyboard 41, e.g., to point to respective displayed keys of the keyboard on opposite sides of an imaginary divider line 42. Moving one of the hands, e.g., the left hand 33, provides an optical input to the camera 20. The image information or data representative of such motion may cause selecting of different respective keys of the keyboard 41 to the left (e.g., below relative to the illustration of FIG. 6A) of the divider line 42. The highlighted key representing the letter R is shown in FIG. 6A; moving one the hand 33 to the left (down relative to the illustration), while the other hand 34 is kept still, may cause the key representing the letter E to become highlighted; moving the hand 33 to the right as illustrated in the drawing, e.g., away from the display device 31, may cause the letter D or F to become highlighted. The highlighted key may be selected by effecting a clicking action by the other hand, e.g., the right hand 34 in the manner described above. For example, as is represented in FIG. 6B, the right hand 34 may be lifted out of the view of the camera 21 and quickly placed back down on the table 35 in the view of the camera 21. The letter that had been highlighted then would be selected, e.g., for use in a word processing program, to present a label on an image shown on the display device, etc. According to another embodiment, movement, such as a single or multiple tapping action (e.g., raising and lowering) of a finger of a hand may be provided as optical input to one of the cameras and detected to provide in effect a selecting function to select a given letter of the keyboard 41 or of any of the other content described herein. The foregoing is an example of use of the invention to provide alphanumeric for virtually any use as may be desired.

Referring to FIGS. 1A and 7, an electronic device in the form of a mobile phone 10 is shown. The mobile phone 10 includes a wireless connection and communication function and a messaging function, e.g., SMS, collectively shown at 43 that is configured carry out various connection, communication and messaging functions that are known for wireless electronic devices, e.g., mobile phones. The communication function 43 may be embodied as executable code that is resident in and executed by the electronic device 10. In one embodiment, the communication function 43 may be one or more programs that are stored on a computer or machine readable medium. The communication function 43 may be a stand-alone software application or form a part of a software application that carries out additional tasks related to the electronic device 10.

Also, through the following description, exemplary techniques for connecting, communicating, transmitting content, receiving and analyzing optical input, e.g., by the cameras 20, 21, etc., as are mentioned above, for example, are described further below. It will be appreciated that through the description of the exemplary techniques, a description of steps that may be carried out in part by executing software is described. The described steps are the foundation from which a programmer of ordinary skill in the art may write code to implement the described functionality. As such, a computer program listing is omitted for the sake of brevity. However, the described steps may be considered a logical routine that the corresponding device is configured to carry out. Also, while the communication function 43 and other functions described herein are implemented partly in software in accordance with an embodiment, such functionality could also be carried out via dedicated hardware or firmware, or some combination of hardware, firmware and/or software.

The display 18 of the mobile phone 10 displays information to a user such as operating state, time, telephone numbers, contact information, various menus, etc., that enable the user to utilize the various features of the mobile phone 10. The display 44 also may be used to visually display content received and/or to be output by the mobile phone 10 and/or retrieved from a memory 46 of the mobile phone 10. The display 18 may be used to present images, video and other graphics to the user, such as photographs, mobile television content, Internet pages, and video associated with games.

The keypad 13 provides for a variety of user input operations. For example, the keypad 13 may include alphanumeric keys for allowing entry of alphanumeric information (e.g., telephone numbers, phone lists, contact information, notes, text, etc.), special function keys (e.g., a call send and answer key, multimedia playback control keys, a camera shutter button, etc.), navigation and select keys or a pointing device, and so forth. Keys or key-like functionality also may be embodied as a touch screen associated with the display 18. Also, the display 18 and keypad 13 may be used in conjunction with one another to implement soft key functionality.

The electronic device 10 includes communications circuitry generally illustrated at 11c in FIG. 7 that enables the electronic device to establish a communications with another device. Communications may include calls, data transfers, and the like, including providing of content and/or other signals via the connection 32 to a display device 31, as is described above. Communications also may include wireless communications with a WLAN or other network, etc. Calls may take any suitable form such as, but not limited to, voice calls and video calls. The calls may be carried out over a cellular circuit-switched network or may be in the form of a voice over Internet Protocol (VoIP) call that is established over a packet-switched capability of a cellular network or over an alternative packet-switched network (e.g., a network compatible with IEEE 802.11, which is commonly referred to as WiFia or a network compatible with IEEE 802.16, which is commonly referred to as WiMAX), for example. Data transfers may include, but are not limited to, receiving streaming content (e.g., streaming audio, streaming video, etc.), receiving data feeds (e.g., pushed data, podcasts, really simple syndication (RSS) data feeds data feeds), downloading and/or uploading data (e.g., image files, video files, audio files, ring tones, Internet content, etc.), receiving or sending messages (e.g., text messages, instant messages, electronic mail messages, multimedia messages), and so forth. This data may be processed by the mobile phone 10, including storing the data in the memory 46, executing applications to allow user interaction with the data, displaying video and/or image content associated with the data, outputting audio sounds associated with the data, and so forth.

In the exemplary embodiment, the communications circuitry 11c may include an antenna 50 coupled to a radio circuit 52. The radio circuit 52 includes a radio frequency transmitter and receiver for transmitting and receiving signals via the antenna 50. The radio circuit 52 may be configured to operate in a mobile communications system. Radio circuit 52 types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMAX, digital video broadcasting-handheld (DVB-H), integrated services digital broadcasting (ISDB), high speed packet access (HSPA), etc., as well as advanced versions of these standards or any other appropriate standard. It will be appreciated that the electronic device 10 may be capable of communicating using more than one standard. Therefore, the antenna 50 and the radio circuit 52 may represent one or more than one radio transceiver.

The mobile phone includes in the circuitry, software and logic 11c portion, for example, a primary control circuit 60 that is configured to carry out overall control of the functions and operations of the mobile phone 10. The control circuit 60 may include a processing device 62, such as a central processing unit (CPU), microcontroller or microprocessor. The processing device 62 executes code stored in a memory (not shown) within the control circuit 60 and/or in a separate memory, such as the memory 46, in order to carry out operation of the mobile phone 10. For instance, the processing device 62 may 5 execute code that implements the wireless connection and communication function 42, including, for example, SMS or other message function, as well as effecting and/or controlling the connection 32. The memory 46 may be, for example, one or more of a buffer, a flash memory, a hard drive, a removable media, a volatile memory, a non-volatile memory, a random access memory (RAM), or other suitable device. In a typical lo arrangement, the memory 46 may include a non-volatile memory for long term data storage and a volatile memory that functions as system memory for the control circuit 60. The memory 46 may exchange data with the control circuit 60 over a data bus. Accompanying control lines and an address bus between the memory 46 and the control circuit 60 also may be present.

The control circuit 60, processing device 62, connection/communications function 42 and comparator and control function 120 are configured, cooperative and adapted to carry out the steps described herein to provide for remote control of displaying of content from the mobile phone 10.

The mobile phone 10 further includes a sound signal processing circuit 64 for processing audio signals transmitted by and received from the radio circuit 52. Coupled to the sound processing circuit 64 are the microphone 16 and the speaker 17 that enable a user to listen and speak via the mobile phone 10. The radio circuit 52 and sound processing circuit 64 are each coupled to the control circuit 60 so as to carry out overall operation. Audio data may be passed from the control circuit 60 to the sound signal processing circuit 64 for playback to the user. The audio data may include, for example, audio data from an audio file stored by the memory 46 and retrieved by the control circuit 60, or received audio data such as in the form of voice communications or streaming audio data from a mobile radio service. The sound signal processing circuit 64 may include any appropriate buffers, decoders, amplifiers and so forth.

The display 18 may be coupled to the control circuit 60 by a video processing circuit 70 that converts video data to a video signal used to drive the display (and the display device 31). The video processing circuit 70 may include any appropriate buffers, decoders, video data processors and so forth. The video data may be generated by the control circuit 60, retrieved from a video file that is stored in the memory 46, derived from an incoming video data stream that is received by the radio circuit 52 or obtained by any other suitable method. Alternatively, instead of or in addition to a video processing circuitry 70 to operate the display 18, another display driver may be used.

The electronic device 40 may further include one or more input/output (I/O) interface(s) 72. The I/O interface(s) 72 may be in the form of typical mobile telephone I/O interfaces and may include one or more electrical connectors. The I/O interfaces 72 may form one or more data ports for connecting the mobile phone 10 to another device (e.g., a computer) or an accessory (e.g., a personal handsfree (PHF) device) via a cable. Such data ports may be part of the connection 32 to provide content from the mobile phone 10 to the display device 31. Further, operating power may be received over the I/O interface(s) 72 and power to charge a battery of a power supply unit (PSU) 74 within the electronic device 40 may be received over the I/O interface(s) 72. The PSU 74 may supply power to operate the electronic device 40 in the absence of an external power source. The I/O interface 72 may be coupled to receive data input and/or commands from by the keypad 13, from a touch sensitive display 18 and to show/display information via the display and/or via the display device 31.

The circuitry, software and logic 11 of the mobile phone 10 also may include various other components. For instance, a system clock 76 may clock components such as the control circuit 60 and the memory 46. The cameras 20, 21 are included for taking digital pictures and/or movies and for use in obtaining images representing optical input for controlling the presentation system 30, as is described above. Image and/or video files corresponding to the pictures and/or movies may be stored in the memory 46. A position data receiver 80, such as a global positioning system (GPS) receiver, Galileo satellite system receiver or the like, may be involved in determining the location of the electronic device 40. A local wireless interface 82, such as an infrared transceiver and/or an RF transceiver (e.g., a Bluetooth chipset) may be used to establish communication with a nearby device, such as an accessory (e.g., a PHF device), another mobile radio terminal, a computer, a television, a computer monitor, a display device 31, or another device, etc. The local wireless interface 82 may be used as or be part of the connection 32 described above.

It will be appreciated that the processing device 62 may execute code that implements the connection and communications function 43, the providing of content for display or other output via the connection 32 to the display device 31. It will be apparent to a person having ordinary skill in the art of computer programming, and specifically in application programming for mobile telephones or other electronic devices, how to program a mobile phone 10 to operate and carry out logical functions associated with the connection and communications function 42. Accordingly, details as to specific programming code have been left out for the sake of brevity. Also, while the connection and communications function 42 is executed by the processing device 62 in accordance with an embodiment, such functionality could also be carried out via dedicated hardware or firmware, or some combination of hardware, firmware and/or software.

Examples of computer program flow charts or logic diagrams for carrying out the various functions described above, e.g., connection and communications function 42 and displaying of content on a display device 31, are described below. The other typical telephone, SMS and other functions of the mobile phone 10 may be carried out in conventional manner and in the interest of brevity are not described in detail herein; such typical functions and operations will be evident to persons who have ordinary skill in the art of mobile phones, computers and other electronic devices.

With additional reference to FIGS. 8, 9 and 10, illustrated are logical operations to implement exemplary methods of the invention, e.g., displaying of content provided by the mobile phone 10 via connection 32 to the display device. Thus, the flow charts of FIGS. 8, 9 and 10 may be thought of as depicting steps of a method carried out by the mobile phone 10. Although FIGS. 8, 9 and 10 show a specific order of executing functional logic blocks or steps, the order of executing the blocks or steps may be changed relative to the order shown. Also, two or more steps shown in succession may be executed concurrently or with partial concurrence. Certain steps also may be omitted. In addition, any number of functions, logical operations, commands, state variables, semaphores or messages may be added to the logical flow for purposes of enhanced utility, accounting, performance, measurement, troubleshooting, and the like. It is understood that all such variations are within the scope of the present invention.

Exemplary logical flow (flow chart) for carrying out the method and operation of the mobile phone 10 is shown at 100 in FIG. 8. The method or routine commences at the start step 102, e.g., upon turning on or powering up the mobile phone 10. At step 104 an inquiry is made whether a remote control function has been requested or called for, e.g., is it desired to use the mobile phone 10 in a presentation system 30 to show on a display device 31 content that is provided by the mobile phone and is controlled by the hand motions described. If not, then a loop 106 is followed. If yes, then at step 108 communication between the mobile phone 10 and the display device 31 is established, either in a wired or wireless manner via the connection 32, for example. At step 110 an inquiry is made whether writing has been selected, e.g., to carry out the functions described above with respect to FIGS. 6A and 6B. If not, then at step 112 an inquiry is made whether motion has been detected, e.g., hand motion or other optical input as described above that may be provided by one or both cameras 20, 21 as image information that can be used to control operation of the mobile phone in its providing of content for display. If not, then loop 114 is followed. If yes, then at step 116 the motion is decoded. For example, are the hands 33, 34 moved toward or away from the mobile phone 10 to cause a zooming function; is one hand moved to cause a panning function; is a hand or finger pointing to a key to cause a key selection function; is a hand raised out of view of a camera and quickly moved back in view or is a finger or hand tapped; etc.; all of which may provide inputs to and controlling of the mobile phone 10. At step 118 a function is carried out according to the result of decoding of the motion or optical input at step 116. For example, a function that is shown on the display device 31 and possibly also on the display 18 may be selected from a GUI, an image may be zoomed or panned, or a key of a displayed keyboard may be selected, or a list may be scrolled and an item therein selected, etc.

Briefly referring back to FIG. 7, at step 120 as part of the processing device 62 is a comparator and control function. The comparator and control function may be carried out in computer software or logic to determine what is the intended control function to be carried out based on the image or motion that is provided as an optical input to the camera(s) and converted to image information in the Electronic circuitry 11. For example, the comparator portion of the comparator and control function 120 may include an automatic focusing device that adjusts itself to maintain in focus or to try to maintain in focus a hand 33 or 34 from a respective camera 20, 21. Automatic focusing systems are available commercially and are used in many camera systems; such devices may be used to determine the distance of a hand from a camera so that such information may be provided as a signal or the like to control the manner in which content is displayed by the mobile phone 10 and display device 31. The comparator and control function 120 may include a comparator that compares two or more images to determine whether motion is occurring and, if it is, what is the character of the motion, e.g., the speed, direction, change of direction, etc. For example, if an image of a hand 33 is at one location relative to the camera 20 and subsequently is at a different location relative to the camera, by determining the relationship of edges of the hand images obtained at different times or some other determination relative to the several images, direction, speed, etc., can be determined and used to control operation of the mobile phone 10 and the manner in which content is shown on the display device 31.

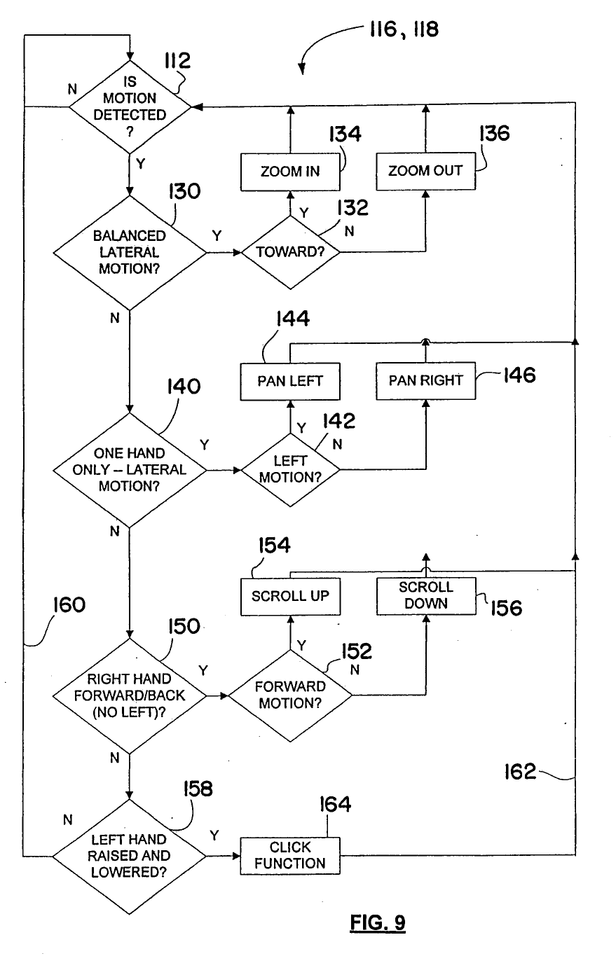

Turning to FIG. 9, the decode motion step 116 and effect function/transmit control 118 of FIG. 8 are shown in greater detail.

At step 112 an inquiry is made whether motion has been detected. Reference to motion in this context may also mean whether the location of a hand, for example, has been detected even if there is no motion when the mobile phone 10 is set up to operate to provide content to the display device 31 and to permit control via location of an object, such as a hand, as an optical input to the mobile phone for remote control and operation as described above.

At step 130 an inquiry is made whether the detected motion is balanced lateral motion, e.g., simultaneous moving of the user's both hands toward or away from the respective cameras 20, 21 of the mobile phone 10, as was described above with respect to FIGS. 3A and 3B. If yes, then at step 132 an inquiry is made whether the hands are moving toward the mobile phone 10. If yes, then at step 134 a zoom in function is carried out; and if not, then at step 136 a zoom out step is carried out.

At step 130, if the detected motion is not balanced lateral motion, then at step 140 an inquiry is made whether the motion is one hand only type of lateral motion, e.g., as is illustrated and described with respect to FIGS. 4A and 4B. If yes, then at step 142 an inquiry is made wither the one hand only lateral motion is motion toward the left, e.g.., by the left hand away from the mobile phone 10. If yes, then at step 144 the image shown on the display device 31 is panned to the left. If not, then at step 146 the image shown on the display device 131 is panned to the right, as was described with respect to FIGS. 4A and 4B.

At step 140, if the detected motion is not one hand only lateral motion, then at step 150 an inquiry is made whether the motion is one hand, e.g., right hand, forward or back motion, as was described above with respect to FIGS. 5A, 5B and 5C. If yes, then at step 152 an inquiry is made whether the detected motion is forward motion, e.g., away from the body of the user and/or toward the display device 31. If yes, then at step 154 the image shown on the display device, e.g., a list, is scrolled up. If no, then at step 156 the image is scrolled down.

If at step 150 the motion is not right hand forward or back without moving the left hand, then at step 158 an inquiry is made whether the left hand is raised and then quickly lowered to symbolize a computer mouse type of click function. If yes, then at step 160 such click function is carried out; and then a loop 162 is followed back to step 112. If at step 158 the left hand has not been raised and lowered to symbolize a click function, then loop 164 is followed back to step 112.

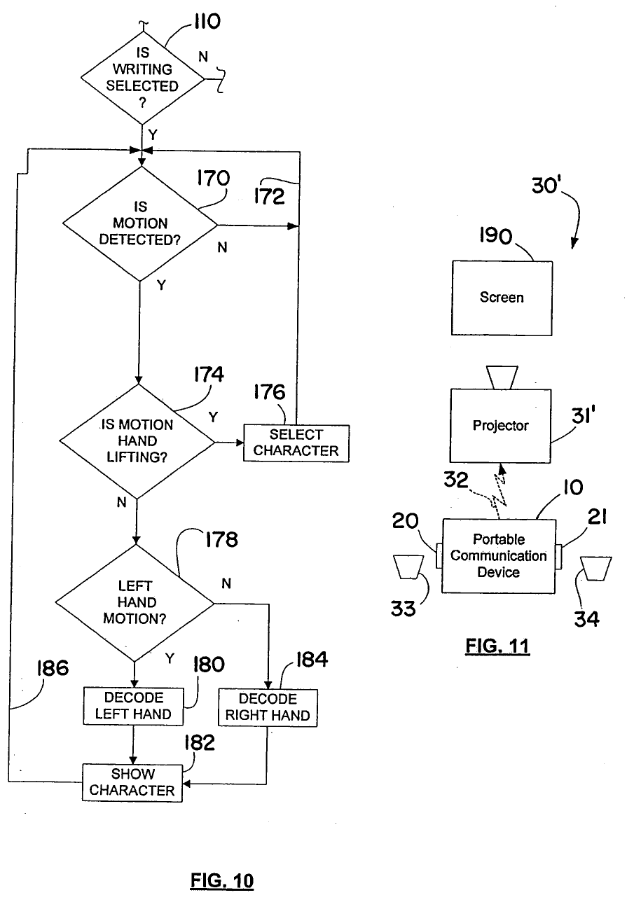

Referring to FIGS. 8 and 10, at step 110, if writing has been selected, e.g., using the displayed keyboard shown and described above with respect to FIGS. 6A and 6B, then at step 170 an inquiry is made whether motion has been detected. If not, then loop 172 is followed. If yes, then at step 174 an inquiry is made whether the motion is hand lifting (or hand or finger tapping), e.g., temporarily out of view of the appropriate camera and then back into camera view to symbolize a computer mouse type of clicking action. If yes, then at step 176 a character is selected, e.g., the character that had been highlighted on the keyboard 41. If no, then at step 178 an inquiry is made whether motion of the left hand 33 had been detected. If yes, then at step 180 the motion of the left hand is decoded to detect which letter of the left side of the divider line 42 of the keyboard 41 is being pointed to and is to be highlighted. Then, at step 182 the character is shown or highlighted. If at step 178 the inquiry indicates that the motion was not of the left hand, then it is understood that the motion was of the right hand 34; and at step 182 that motion is decoded to determine which letter is being pointed to by the right hand 34 at the right side of the divider line 42 relative to the displayed keyboard 41 and should be highlighted. At step 180 such letter is shown or highlighted. Loop 186 then is followed back to step 170. The process may be repeated to form an entire word, sentence, etc. that may be shown on the display device 31, display 18 and/or input to the circuitry 11 (FIG. 7).

Briefly referring to FIG. 11, another embodiment of presentation system 30′ is illustrated. The presentation system 30′ is similar to the presentation system 30 except the display device 31′ is a projector that receives content from the mobile phone 10 and projects images representing the content onto a screen, wall or the like 190. Operation of the presentation system 30′ is the same or similar to the operation of the presentation system 30 described above.

It will be appreciated that the mobile phone 10 used in a presentation system 30, 30′ or otherwise used may be operated by remote control based on location, motion (movement) and/or gesture of a hand or the like of the user.

It will be appreciated that the above-described logic diagrams of FIGS. 8, 9 and 10 100, 120, 140 are exemplary. The mobile phones 10 with the features described herein may be operated in many different ways to obtain the functions and advantages described herein.

As is described above the present invention provides a remote control capability for various devices by using gestures, movement, images, etc. of a user's hands or fingers. It will be appreciated that such gestures, movement, images, etc. of other parts of a person's body or of implements that are held in some way also may be used to provide various optical inputs to carry out the invention. A specified motion may provide an optical input to cause a desired response. For example, rather than sliding hands across a surface, as was described above, a waving motion, a motion making a religious symbol in space, a gesture made by a combination or sequence of finger motions, e.g., similar to sign languages, or arbitrary and/or one or more combinations of these may be used as the optical input to provoke a desired response. One such response may be navigation in displayed information, e.g., scrolling through a list, panning across a map, etc., or to switch operating modes or functions shown in a user interface or GUI (graphical user interface).

Several additional embodiments are illustrated in FIGS. 12-16. These embodiments are illustrated schematically; it will be appreciated that systems, circuitry, methods and operation of the above-described embodiments may be used in combination with the respective embodiments illustrated in FIGS. 12-16.

Briefly referring to FIG. 12, an accessory device 200 is illustrated in combination with a primary device 201. The primary device 201 may be a computer, electronic game, television, or some other device, and the accessory device 200 may be used to provide remote control to and/or content for the primary device, e.g., as was described above with respect to the mobile phone 10. The accessory device 200 includes a pair of cameras 20, 21, e.g., like the cameras 20, 21 described above. The accessory device 200 may include circuitry 202, which may be similar to the circuitry, software and logic 11 described above, that may operate as was described above to provide remote control of and/or content to the primary device 201, e.g., via a wired or wireless connection 32 thereto, to carry out the methods and operations described above. For example, if the primary device 201 were a gaming device, such as an electronic game, hand gestures sensed by the accessory device 200 may provide remote control of the game functions. As another example, if the primary device 200 were a display, television, projector, etc., then using hand gestures, etc. the accessory device 200 may provide remote control operation of the primary device and/or may provide content to be displayed by the primary device.

In FIG. 13 is illustrated an embodiment in which two electronic devices 210, 211 e.g., mobile phones, each having only one camera 212, such as a video camera or other camera able to receive optical inputs and with circuitry 202 to detect motion. The cameras receive optical inputs, such as movement or gestures, etc., and circuitry 202 in the respective mobile phones may detect respective motions received as optical inputs by the cameras and provide a remote control, providing of content, etc. to the primary device 201 via connection 32. Thus, in the embodiment of FIG. 13, rather than one mobile phone having two cameras 20, 21, each mobile phone 210, 211 has a single mobile phone 212 and associated circuitry to carry out the steps described above with respect to the mobile phone 10. The mobile phones 210, 211 the mobile phones 210, 211 may be electrically connected together as is shown at 213 by a wired connection or by a wireless connection so that the respective optical inputs received by the cameras 212 can be used by circuitry in one or both mobile phones 210, 211, as was described above with respect to the mobile phone 10, to detect gestures, motion or the like to effect remote control of the primary device 201 and/or to provide content to the primary device.

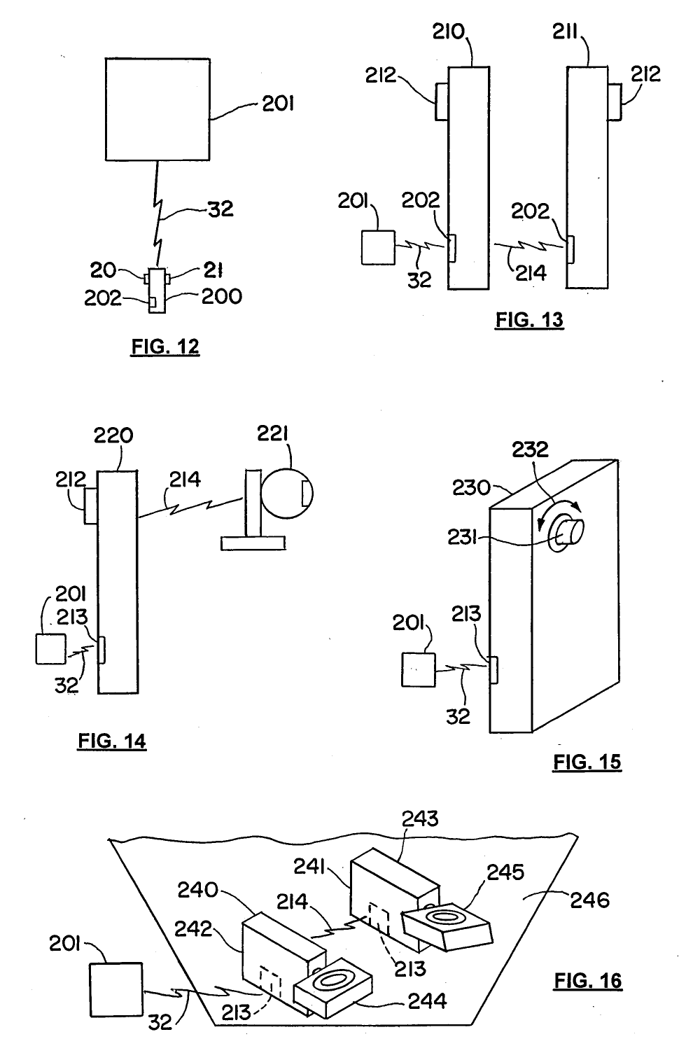

In still another embodiment illustrated in FIG. 14 an electronic device 220, for example a mobile phone, and a web camera (computer camera, etc.) 221 may be used to provide the camera functions receiving optical inputs of gestures, movements, motion, or the like, to provide image signals to circuitry 213 to detect the gestures, movements, motions, etc. to provide by signals or the like transmitted via the connection 32 for remote control and/or delivery of content for a primary device 201. Circuitry 213 may receive image information from the camera 221 via connection 214 and may receive image information from the camera 212 of the electronic device 220.

FIG. 15 illustrates an electronic device 230, e.g., a mobile phone, that has a movable camera 231. Circuitry 213 may control operation of the camera 231 to rotate, pivot, swing or otherwise move the camera, as is schematically represented by the arrow 232, so that it may receive optical inputs from several different directions. The circuitry 213 may decode image information or signals representative of the optical inputs thereby to provide for remote control and/or for delivery of content to a primary device 201 via a connection 32, e.g., generally as was described above.

FIG. 16 illustrates another embodiment in which the electronic devices 240, 241, e.g., mobile phones, that have a main body 242, 243 and a camera 244, 245 that is movable, e.g., rotatable, relative to the main body. The mobile phones 240, 241 are shown resting on a table or other surface 246 with the respective cameras 244, 245 rotated or tilted in different respective directions so as to receive different respective optical inputs. Since the cameras are tilted to face somewhat in an upward direction relative to the surface 246, the optical inputs, e.g., motions or gestures, would come from above the mobile phones. Therefore, the optical input may be a hand gesture, e.g., waving or other moving of respective hands above a respective phone, movement of another body portion, e.g., tilting of a person's head or two person's heads, respectively, or some other optical input. Although the cameras are shown facing upward but tilted in different directions, it will be appreciated that the cameras may be adjusted to face in other directions, as may be desired, to receive desired optical inputs. Operation of circuitry 213, connection 214, and connection 32 to effect control and/or delivery of content to the primary device 201 may be as described above, for example.

As is described above with respect to FIG. 1, for example, the main body 242, 243 of the electronic devices 240, 241 may have a display 18. Since the cameras 244, 245 may be rotated relative to the respective main bodies, it is possible to position the electronic devices 240, 241 in an orientation such that a user may view one or both displays while the respective cameras are oriented to receive optical inputs from the hands, fingers, other body portions, etc. of the user. Therefore, in using the electronic devices, the user may provide respective optical inputs, e.g., gestures, motion or the like, to effect a remote control function while observing the result in a display or on both displays instead of or in addition to providing control of a main device 201 or delivery of content to the display(s) and/or main device. Sometimes in conventional electronic devices it is a problem to view the display while also controlling the device by pressing buttons, moving slides, etc., because placing a hand to do such control obstructs a view of the display. Such problem can be overcome by using gestures to provide remote control as the optical inputs are received by the respective cameras that can be tilted, rotated, etc. to acquire optical inputs from locations that are out of the user's line of sight to the display(s) and thereby to provide remote control of the electronic devices without obstructing viewing of the display(s).

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions or blocks in flow charts may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps represented in the flow diagrams of the drawings, which, for example, may be considered an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

Although certain embodiments have been shown and described, it is understood that equivalents and modifications falling within the scope of the appended claims will occur to others who are skilled in the art upon the reading and understanding of this specification.

1. A portable electronic device, comprising
an input device adapted to receive a plurality of input images,
a comparator configured to recognize at least one of a plurality of predetermined motions by comparing input images, and
a controller configured to control an output of the portable electronic device in response to the respective motions recognized by the comparator, wherein the type of control corresponds to the recognized motion.

2. The device of claim 1, further comprising an output device configured to provide such output as displayable content.

3. The device of claim 2, wherein the displayable content is at least one of a picture, a list, or a keyboard.

4. The device of claim 2, wherein said comparator is configured to recognize a plurality of different predetermined motions, and the controller is configured to change at least one of size or location of an image of displayable content in response to respective motions recognized by the comparator.

5. The device of claim 2, wherein the controller is configured to scroll an image of displayed information in response to respective motions recognized by the comparator.

6. The device of claim 2, wherein the controller is configured to cause a selection function with respect to an image of displayed information in response to respective motions recognized by the comparator.

7. The device of claim 2, wherein the output device is configured to transmit the displayable content by wireless, wired or other coupling to be shown by at least one of a television, projector, display, monitor, or computer that is remote from the portable electronic device.

8. The device of claim 1, wherein the comparator comprises a processor and associated logic configured to compare a plurality of images.

9. The device of claim 1, wherein the comparator is configured to compare recognized motions represented, respectively, by a first plurality of input images from a first direction and by a second plurality of input images from a second direction that is different from the first direction.

10. The device of claim 1, said input device comprising at least one camera.

11. The device of claim 1, said input device comprising two cameras relatively positioned to receive input images from different directions.

12. The device of claim 11, wherein at least one of the cameras is a video camera.

13. The device of claim 1, comprising a mobile phone having two cameras as the input device to provide input images from different directions, and wherein one camera is a video call camera and the other is a main camera of the mobile phone.

14. A method of operating a portable electronic device, comprising
comparing input images to recognize at least one of a plurality of predetermined motions, and
controlling an output of the portable electronic device in response to the respective recognized motions, wherein the type of controlling corresponds to the recognized motion.

15. The method of claim 14, said comparing further comprising comparing recognized motions represented, respectively, by a first plurality of input images from a first direction and by a second plurality of input images from a second direction that is different from the first direction.

16. The method of claim 14, said controlling an output comprising controlling content intended to be displayed.

17. The method of claim 14, said controlling comprising controlling content provided by the portable electronic device to be shown on a device separate from the portable electronic device.

18. (canceled)

19. The method of claim 14, wherein the portable electronic device is a mobile phone, and further comprising using two cameras of the mobile phone to obtain input images from two different directions for use in carrying out the comparing step.

20. The method of claim 14, wherein at least one of the portable electronic devices includes a display, and comprising providing optical inputs to the portable electronic devices substantially without obstructing a view of the display.

21. Computer software embodied in a storage medium to control an electronic device, comprising
comparing logic configured to compare input images to recognize whether motion having a predetermined characteristic is represented by the results of the comparison,
control logic responsive to recognizing by the comparing logic of motion having a predetermined characteristic and configured to provide a type of control of an output of the electronic device in correspondence to the recognized motion.

22. The computer software of claim 20, said comparing logic further comprising logic configured to compare two recognized motions having respective predetermined character motions.

23. (canceled)

24. (canceled)
